(19) United States
(12) Patent Application Publication
(10) Pub. No.: US 2017/0112211 A1
(43) Pub. Date: Apr. 27, 2017

(54) LAMINATED MATERIAL

(71) Applicant: Joseph Cleary Dolcetti, KUALA LUMPUR (MY)

(72) Inventor: Joseph Cleary Dolcetti, KUALA LUMPUR (MY)

(21) Appl. No.: 15/318,179

(22) PCT Filed: Apr. 1, 2015
(86) PCT No.: PCT/MY2015/050021

§ 371 Date: Dec. 12, 2016

(30) Foreign Application Priority Data
Jun. 11, 2014 (MY) PI2014701553

(51) Int. Cl. A41D 31/00; B32B 5/02; A44B 18/00; B32B 25/10; B32B 3/30; B32B 3/26; B32B 5/18; B32B 7/12

(52) U.S. Cl. CPC A41D 31/0083; B32B 5/18; B32B 5/024; B32B 5/026; B32B 7/12; B32B 25/10; B32B 3/30; B32B 3/266; A44B 18/0034; B32B 2262/0261; B32B 2307/51; B32B 2437/00; B32B 2307/726; A41D 2400/22

(57) ABSTRACT

A laminated material for clothing comprises at least three layers of flexible elastic material, the first, outer, layer comprising a material with a plush surface having a multitude of mini-loops for forming a hook and loop connection with a material, which does not form part of the material of the invention, having a surface having a multitude of mini-hooks, the middle layer being of an elastomeric material and the third, inner, layer being of a non-allergenic elastic material, wherein the material is omnidirectionally stretchable and the strength of the material is such appropriate weighty articles can be attached to the outer surface of a garment made from the material without dragging the garment out of shape, and has moisture wicking and antimicrobial properties, is non-allergenic and has no undesirable skin effects and at least one layer is perforated.

### FIELD OF INVENTION

This invention relates to laminated materials, particularly for use as materials for making garments, especially exercise and sportswear and, more especially exercise and sports training wear.

### BACKGROUND TO THE INVENTION

For the purposes of this specification the word “garment” is to be understood as referring not only to complete garments but also to parts of articles, such as arm or leg coverings.

Exercise and sportswear exists in many forms depending on the activity involved. For some activities, such as golf, ordinary casual clothing can be worn but for other sporting or training activities, such as military exercise training, martial arts, weight training and many other activities sport playing or training, it is desirable that specially designed clothing and clothing materials are used. While attempts have been made to idealise the properties of the materials used to make the garments, no material has so far been available that has the properties that make it universably usable in the manufacture of a wide range of exercise and sportswear .

### SUMMARY OF THE INVENTION

This invention provides a material that fulfills the desired requirements of material for making exercise and sportswear for use in a wider range of specific activities to a far greater degree than any material that has hitherto been available.

According to the invention, a laminated material for clothing comprises at least three layers of flexible elastic material, a first, outer, layer comprising a material with a plush surface having a multitude of mini-loops for forming a hook and loop connection with a material, which does not form part of the material of the invention, having a surface having a multitude of mini-hooks, an intermediate layer and a third, inner, layer of a non-allergenic material, wherein the material is omnidirectionally stretchable, has moisture wicking and antimicrobial properties and is non-allergenic and has no undesirable skin effects and at least one layer is perforated and wherein the strength of the material is such that articles can be attached to the outer surface of a garment made from the material without dragging the garment out of shape.

The material should also be such that garments made from it should provide a compression effect while still being functional and easy to put on and take off and move around in comfortably

Preferably the material is through perforated.

Preferably, the first layer is an unbrushed loop UBL OK plush cloth to which can be attached articles that have a surface covering, or are encased within a pouch or the like, of a flexible material with surface mini Velcro-type loops. Such articles may be, for example, training weights, bio sensors for heart rate, force, speed, calorific output, or acceleration, pedometers, inertia gauges, GPS units, protective padding for various body parts, such as soccer shin guards, or personal music or communication devices.

The outer layer preferably has a thickness between 1 and 5 mm.

The intermediate layer is preferably an open or closed cell natural or synthetic rubber and is advantageously neoprene. It may vary in thickness depending on the purpose for which the material is to be used. It will normally be between 0.5 and 5 mm thick.

The inner layer is preferably a nylon/spandex blend, which has inherent anti-microbial properties and moisture wicking properties or has been treated to have such properties. It may be a woven or knitted material, if desired. Its thickness is preferably less than 2 mm.

The material of the invention is preferably produced by applying adhesive to the layer materials and pressing the layers between rollers.

The invention also provides a garment or a part of a garment preferably a sportswear garment produced from the material according to the invention. For the purposes of this specification the word garment means anything that can be worn on or wrapped around the entire human body or a part thereof, such as a limb or part of a limb or the head or part of the head. Thus a garment can be, for example, something that can be wrapped around an arm, leg, hand or foot or a part of an arm or a leg or be a hood or a hat.

1.-10. (canceled)

11. A laminated material for clothing comprising at least three layers of flexible elastic material, a first, outer, layer comprising a material with a plush surface having a multitude of mini-loops for forming a hook and loop connection with a material, which does not form part of the material of the invention, having a surface having a multitude of mini-hooks, an intermediate layer and a third, inner, layer of a non-allergenic material, wherein the material is omnidirectionally stretchable, has moisture wicking and antimicrobial properties and is non-allergenic and has no undesirable skin effects and at least one layer is perforated and wherein the strength of the material is such that articles can be attached to the outer surface of a garment made from the material without dragging the garment out of shape.

12. The material according to claim 11, wherein the first layer is an unbrushed loop UBL OK cloth.

13. The material according to claim 11, wherein the intermediate layer is an open or closed cell natural or synthetic rubber.

14. The material according to claim 11, wherein the intermediate layer is neoprene.

15. The material according to claim 11, wherein the inner layer is a nylon/spandex blend.

16. The material according to claim 11, wherein the inner layer is a woven material.

17. The material according to claim 11, wherein the inner layer is a moisture wicking layer.

18. The material according to claim 17, wherein perforations pass wholly through the material.

19. A garment or a part of a garment produced from a material according to claim 11.

20. An exercise or sportswear garment or a part thereof according to claim 19.
